(19) United States
(12) Patent Application Publication
(10) Pub. No.: US 2015/0369272 A1
(43) Pub. Date: Dec. 24, 2015

(54) THERMALLY-ISOLATING FASTENER

(71) Applicant: Columbia Insurance Company, Omaha, NE (US)

(72) Inventor: Ronald P. Hohmann,, JR., Hauppauge, NY (US)

(21) Appl. No.: 14/313,645

(22) Filed: Jun. 24, 2014

(51) Int. Cl. F16B 35/06

(52) U.S. Cl. CPC F16B 35/06

(57) ABSTRACT

A thermally-isolating fastener for use in a cavity wall to connect a wall anchor to an inner wythe includes a fastener shaft having a screw portion including a driven end and an attachment portion opposite the driven end. A fastener head is selectively attachable to the attachment portion of the fastener shaft. The fastener head includes an internal portion and an external portion encasing the internal portion. The external portion is configured to provide a thermal break in the cavity wall when installed.

### FIELD OF THE INVENTION

The present invention generally relates to anchoring systems for insulated cavity walls, and more specifically, a thermally-isolating fastener that creates a thermal break in a cavity wall.

### BACKGROUND

Anchoring systems for cavity walls are used to secure veneer facings to a building and overcome seismic and other forces (e.g., wind shear, etc.). Anchoring systems generally form a conductive bridge or thermal pathway between the cavity and the interior of the building through metal-to-metal contact. Optimizing the thermal characteristics of cavity wall construction is important to ensure minimized heat transfer through the walls, both for comfort and for energy efficiency of heating and air conditioning. When the exterior is cold relative to the interior of a heated structure, heat from the interior should be prevented from passing through to the outside. Similarly, when the exterior is hot relative to the interior of an air conditioned structure, heat from the exterior should be prevented from passing through to the interior. The main cause of thermal transfer is the use of anchoring systems made largely of metal components (e.g., steel, wire formatives, metal plate components, etc.) that are thermally conductive. While providing the required high-strength within the cavity wall system, the use of metal components results in heat transfer. Failure to isolate the metal components of the anchoring system and break the thermal transfer results in heating and cooling losses and in potentially damaging condensation buildup within the cavity wall structure. However, a completely thermally-nonconductive anchoring system is not ideal because of the relative structural weakness of nonconductive materials.

### SUMMARY

In one aspect, a thermally-isolating fastener for use in a cavity wall to connect a wall anchor to an inner wythe includes a fastener shaft having a screw portion including a driven end and an attachment portion opposite the driven end. A fastener head is selectively attachable to the attachment portion of the fastener shaft. The fastener head includes an internal portion and an external portion encasing the internal portion and configured to provide a thermal break in the cavity wall when installed.

In another aspect, an anchoring system for use in a cavity wall having an inner wythe and an outer wythe spaced from the inner wythe and forming a cavity therebetween includes a wall anchor configured for attachment to the inner wythe. The wall anchor includes a mounting surface configured for engagement with an exterior surface of the inner wythe and a receptor configured for engagement with a veneer tie. The wall anchor defines at least one mounting opening. At least one thermally-isolating fastener is configured to extend through the at least one mounting opening to attach the wall anchor to the inner wythe. The at least one thermally-isolating fastener includes a fastener shaft having a screw portion including a driven end and an attachment portion opposite the driven end. A fastener head is selectively attachable to the attachment portion of the fastener shaft. The fastener head includes an internal portion and an external portion encasing the internal portion and configured to provide a thermal break in the cavity wall when installed.

Other objects and features will be in part apparent and in part pointed out hereinafter.

### BRIEF DESCRIPTION OF THE DRAWINGS

FIG. 1 is a perspective of a surface-mounted anchoring system as applied to a cavity wall with an inner wythe of an insulated dry wall construction and an outer wythe of brick;

FIG. 2 is a perspective of the surface-mounted anchoring system of FIG. 1 illustrating a wall anchor and mounting fasteners used to mount the wall anchor to the inner wythe;

FIG. 3 is a front view of a thermal fastener according to an embodiment of the present invention, illustrating an internal portion in phantom;

FIG. 4 is a top view thereof;

FIG. 5 is a bottom view thereof;

FIG. 6 is a section taken through line 6-6 of FIG. 3;

FIG. 7 is an exploded view of the thermal fastener of FIG. 3;

FIG. 8 is a partially exploded front view of the thermal fastener with a neoprene washer;

FIG. 9 is a front view of the thermal fastener;

FIG. 10 is a front view of another embodiment of a thermal fastener according to the present invention;

FIG. 11 is a front view of another embodiment of a thermal fastener according to the present invention; and

FIG. 12 is a front view of another embodiment of a thermal fastener according to the present invention.

Corresponding reference characters indicate corresponding parts throughout the drawings.

### DESCRIPTION OF THE PREFERRED EMBODIMENTS

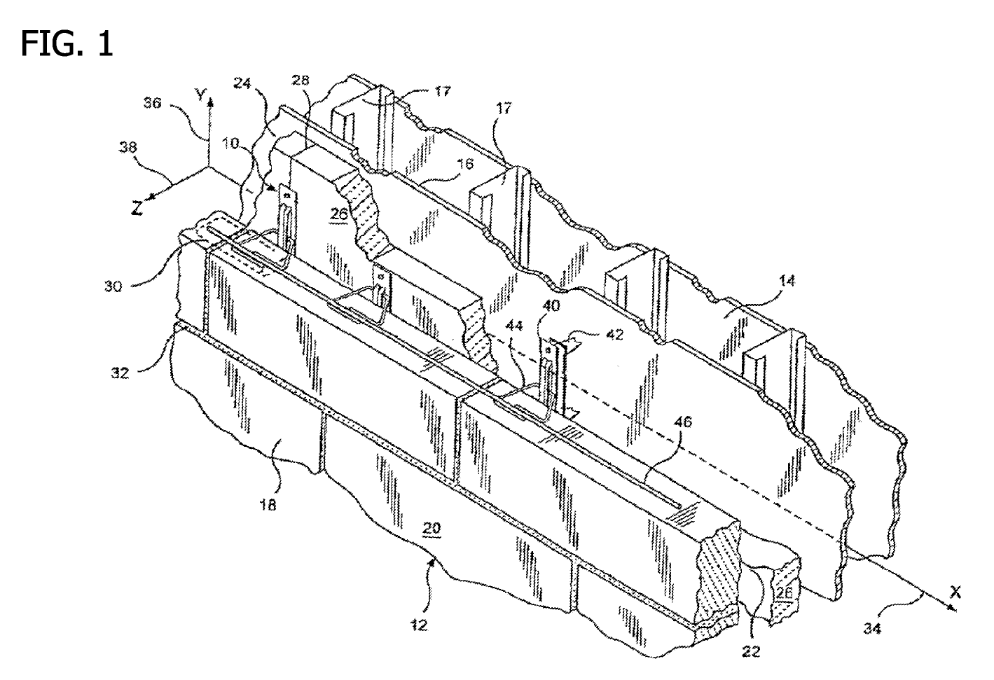

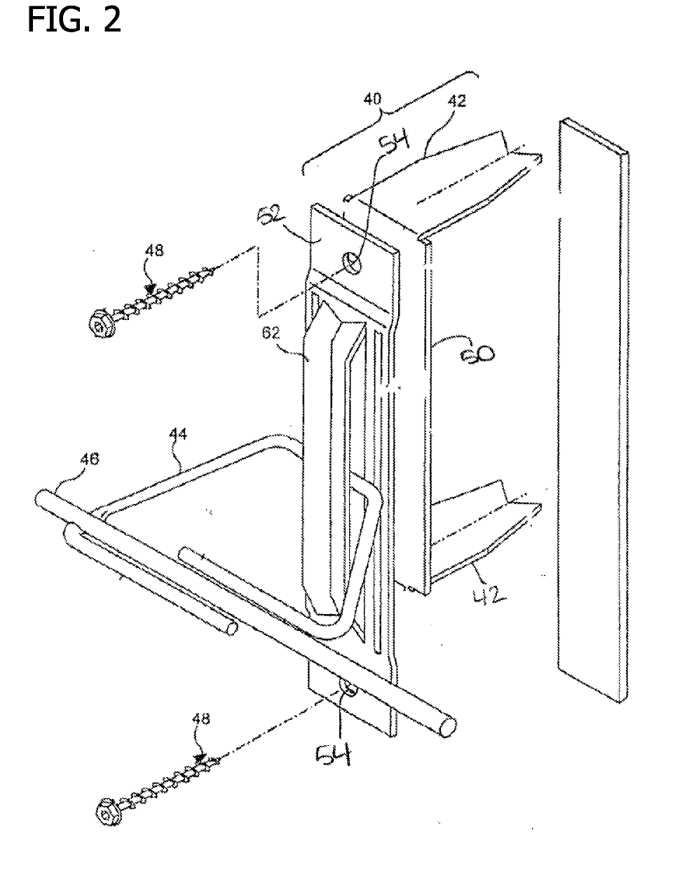

Referring to FIGS. 1 and 2, an anchoring system for cavity walls is shown generally at 10. A cavity wall structure generally indicated at 12 comprises an inner wythe or drywall backup 14 with sheetrock or wallboard 16 mounted on metal columns or studs 17 and an outer wythe or facing wall 18 of brick 20 construction. Between the inner wythe 14 and the outer wythe 18, a cavity 22 is formed. An air/vapor barrier (not shown) and insulation 26 are attached to an exterior surface of the inner wythe 14.

Successive bed joints 30 and 32 are substantially planar and horizontally disposed and, in accordance with building standards, are approximately 0.375 inches in height in a typical embodiment. Selective ones of bed joints 30 and 32, which are formed between courses of bricks 20, are constructed to receive the insertion portion of a veneer tie 44. It is understood that the described and illustrated wall structure 12 is exemplary only. Other structures may be used without departing from the scope of the present invention. A wall anchor 40 is surface mounted on the inner wythe 14 and is supported by the inner wythe. As described in greater detail below, the wall anchor 40 is mounted on the inner wythe with thermally-isolating fasteners 48. The anchoring system 10 is constructed and configured to minimize air and moisture penetration around the wall anchor system/inner wythe juncture and limit thermal transfer.

For purposes of the description, an exterior cavity surface 24 of the inner wythe 14 contains a horizontal line or x-axis 34 and an intersecting vertical line or y-axis 36. A horizontal line or z-axis 38, normal to the xy-plane, passes through the coordinate origin formed by the intersecting x- and y-axes.

In the illustrated embodiment, the anchoring system 10 includes wall anchor 40, veneer tie 44, and an optional wire or outer wythe reinforcement 46. At intervals along the exterior surface 24 of the inner wythe 14, wall anchors 40 are mounted on the inner wythe 14. The wall anchor 40 includes a mounting face or surface 50 and an outer face or surface 52. The mounting face 50 is configured to be positioned adjacent the exterior surface 24 of the inner wythe 14. A pair of legs 42 extend from the mounting surface and are configured to penetrate the insulation 26. As installed, the mounting face 50 covers the opening formed by the insertion of the legs 42 into the insulation 26, thereby maintaining insulation integrity and precluding the passage of air and moisture through the openings formed by the legs. The wall anchor 40 includes a receptor portion 62 configured to extend into the cavity 22 and configured for engagement with the veneer tie 44. Wall anchors and veneer ties can be configured in other ways within the scope of the present invention

The wall anchors 40 are attached to the metal studs 17 with thermally-isolating fasteners or mounting hardware 48 that are configured to provide a thermal break in the cavity 22. Through the use of the thermally-isolating fastener, the underlying metal components obtain a lower thermal conductive value (K-value), thereby providing a high strength anchor with the benefits of thermal isolation. Likewise, the entire cavity wall obtains a lower transmission value (U-value), thereby providing an anchoring system with the benefits of thermal isolation. The term K-value is used to describe the measure of heat conductivity of a particular material, i.e., the measure of the amount of heat, in BTUs per hour, that will be transmitted through one square foot of material that is one inch thick to cause a temperature change of one degree Fahrenheit from one side of the material to the other (BTU/(hr·ft·° F.); or W/(m·K) in SI units). The lower the K-value, the better the performance of the material as an insulator. The metal components of the anchoring systems generally have a K-value range of 16 to 116 W/(m·K) (about 9 to 67 BTU/(hr·ft·° F.)). The thermally-isolating fasteners as described below greatly reduce the K-values to a low thermal conductive K-value not to exceed 1 W/(m·K) (about 0.58 BTU/(hr·ft·° F.)), for example about 0.7 W/(m·K) (about 0.4 BTU/(hr·ft·20 F.)). The term U-value is used to describe the transmission of heat through the entire cavity wall (including the anchor, the insulation, and other components), i.e., the measure of the rate of transfer of heat through one square meter of a structure divided by the difference in temperature across the structure. Similar to the K-value, the lower the U-value, the better the thermal integrity of the cavity wall, and the higher the U-value, the worse the thermal performance of the building envelope. The U-value is calculated from the reciprocal of the combined thermal resistances of the materials in the cavity wall, taking into account the effect of thermal bridges, air gaps and fixings. Several factors affect the U-value, such as the size of the cavity, the thickness of the insulation, the materials used, etc. Desirably, the use of anchor as described herein may reduce the U-value of a wall by 5% -80%.

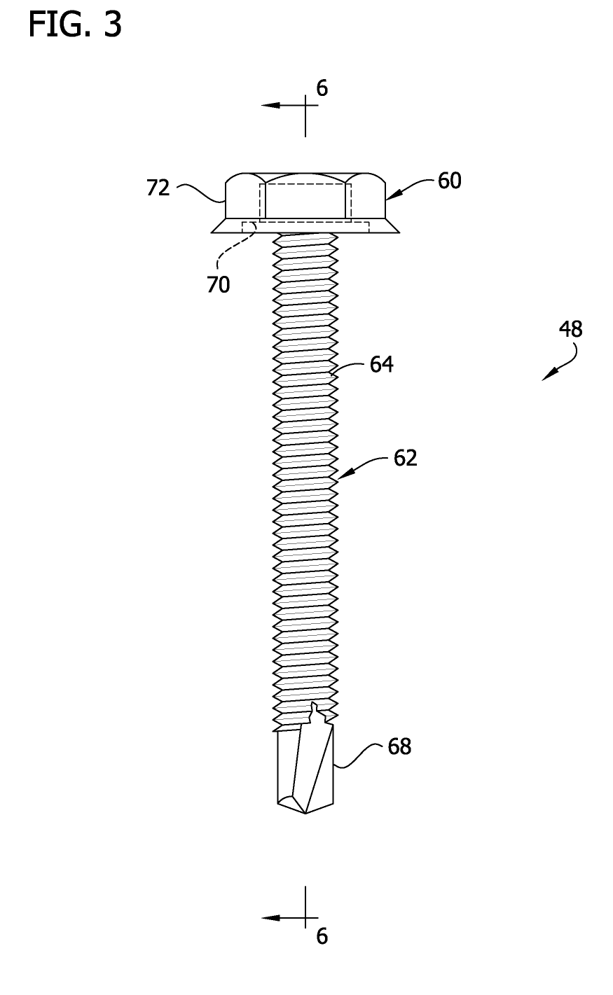

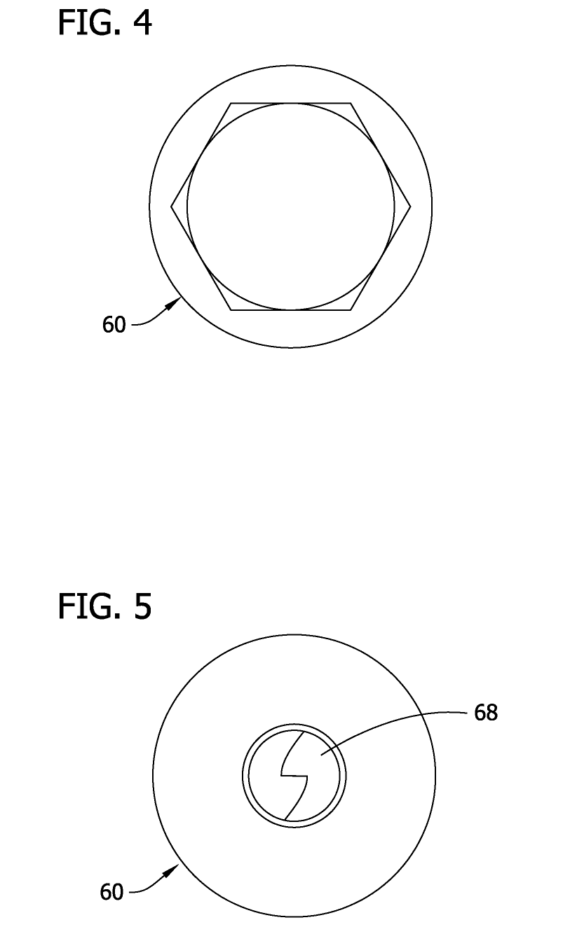

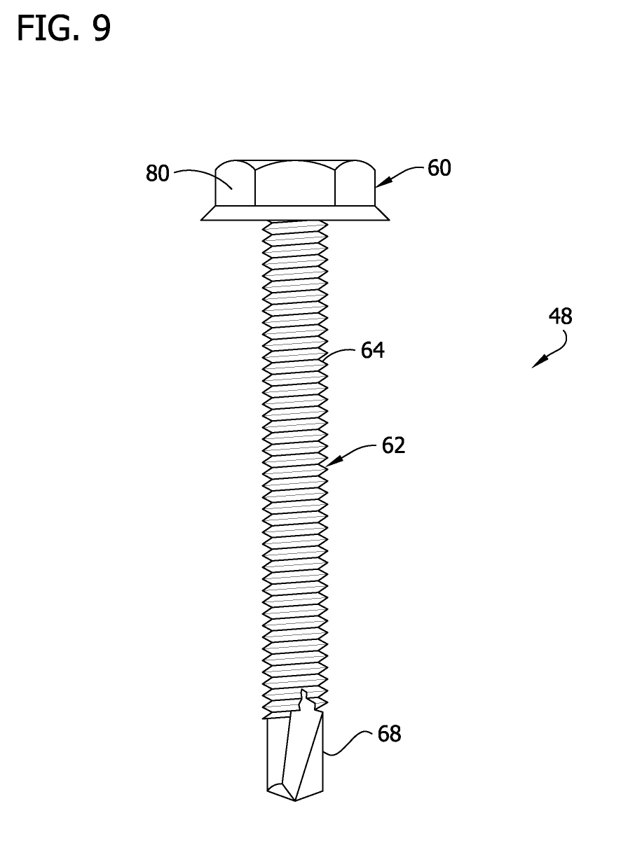

The thermally-isolating fasteners 48 extend through mounting openings 54 in the wall anchor 40 to connect the wall anchor to the metal stud 17. In the embodiment illustrated in FIGS. 3-9, the fastener 48 includes a fastener head 60 selectively attachable to a fastener shaft 62. The fastener 48 is configured to provide a thermal break between the anchor 40 and the inner wythe 14 and also configured to attach the anchor to the inner wythe.

The fastener shaft 62 includes a screw portion 64 having a first diameter and an attachment portion 66 configured for selective attachment to the fastener head 60. The screw portion 64 includes a driven end 68 configured to be driven into the stud 17 to mount the wall anchor 40 to the stud. The screw portion 64 can be a standard self-drilling screw, as is known in the art. The screw portion 64 can be stainless steel or other suitable metal, or can be a polymer coated metal screw. The screw portion 64 can include a thermal coating to reduce the thermal conductivity of the anchoring system, as described below. In the illustrated embodiment, the attachment portion 66 is a threaded stud extending from the screw portion 64 opposite the driven end 68 and configured for attachment to the fastener head 60. The threaded stud attachment portion 66 has a second diameter smaller than the first diameter of the screw portion 64. The attachment portion 66 can be made of the same material as the screw portion 64 (e.g., stainless steel, other suitable metal, or polymer coated metal). Although a threaded stud is illustrated, other configurations for the attachment portion are within the scope of the present invention.

Any part of the fastener shaft 62 (the screw portion 64, the attachment portion 66, the driven end 68) can include a thermally-isolating coating. In one embodiment, every part of the fastener shaft 62 includes a thermal coating to provide a thermal break in the cavity. The thermal coating is selected from thermoplastics, thermosets, natural fibers, rubbers, resins, asphalts, ethylene propylene diene monomers, and admixtures thereof and can be applied in layers. The thermal coating optionally contains an isotropic polymer which includes, but is not limited to, acrylics, nylons, epoxies, silicones, polyesters, polyvinyl chlorides, polyethylenes, and chlorosulfonated polyethylenes. Alternatively, the thermal coating can be a ceramic or ceramic-based coating including materials selected from lanthanum, cerium, praseodymium, neodymium, promethium, samarium, europium, gadolinium, terbium, dysprosium, holmium, erbium, thulium, ytterbium, lutetium, indium, scandium, yttrium, zirconium, hafnium, titanium, silica, zirconia, magnesium zirconate, yttria-stabilized zirconia, and derivatives and admixtures thereof. An initial layer of the thermal coating can be cured to provide a pre-coat and the layers of the thermal coating can be cross-linked to provide high-strength adhesion to the fastener shaft 62 to resist chipping or wearing of the thermal coating.

The thermal coating reduces the K-value of the underlying metal components which include, but are not limited to, mill galvanized, hot galvanized, and stainless steel. Such components have K-values that range from 16 to 116 W/(m·K). The thermal coating reduces the K-value of the fastener shaft 62 to not exceed 1.0 W/(m·K). Likewise, the thermal fastener reduces the U-value of the cavity wall structure. Preferably, the U-value of the cavity wall structure including the thermal fastener is reduced by 5-80% as compared to the U-value of the cavity wall structure including a fastener without the thermal coating described herein. It is understood that other factors affect the U-value, such as the size of the cavity, the thickness of the insulation, the materials used, etc. The thermal coating is fire resistant and gives off no toxic smoke in the event of a fire. Furthermore, the coating is suited to the application in an anchoring system with characteristics such as shock resistance, non-frangibility, low thermal conductivity and transmissivity, and a non-porous resilient finish. Additionally, the thermal coating can provide corrosion protection which protects against deterioration of the anchoring system over time.

The thermal coating can be applied through any number of methods including fluidized bed production, thermal spraying, hot dip processing, heat-assisted fluid coating, or extrusion, and includes both powder and fluid coating to form a reasonably uniform coating. A coating having a thickness of about 3 to 300 microns is optimally applied, and in one embodiment is about 127 microns. The thermal coating is applied in layers in a manner that provides strong adhesion to the fastener shaft 62. The thermal coating is cured to achieve good cross-linking of the layers. Appropriate examples of the nature of the coating and application process are set forth in U.S. Pat. No. 6,284,311 and 6,612,343.

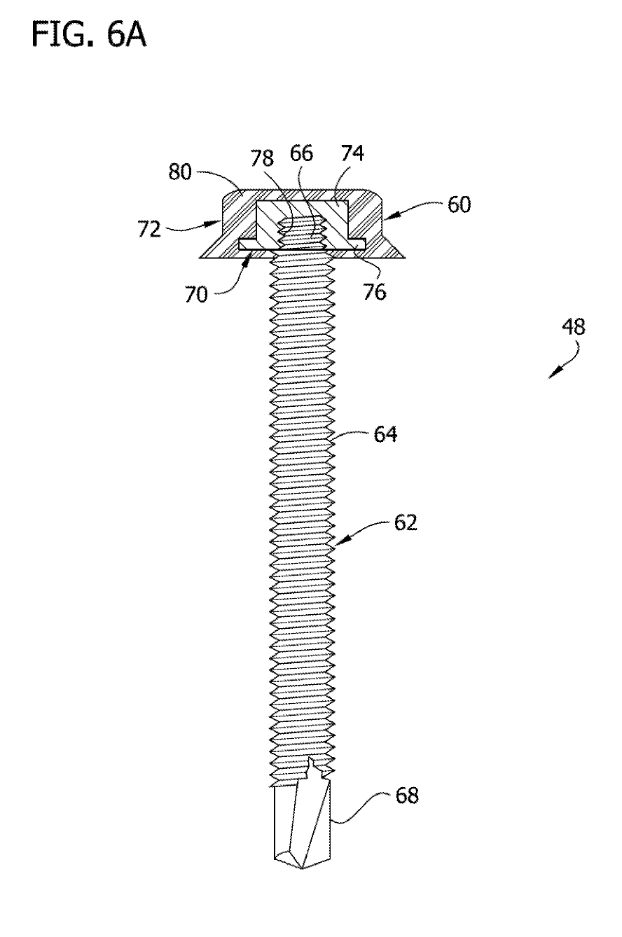

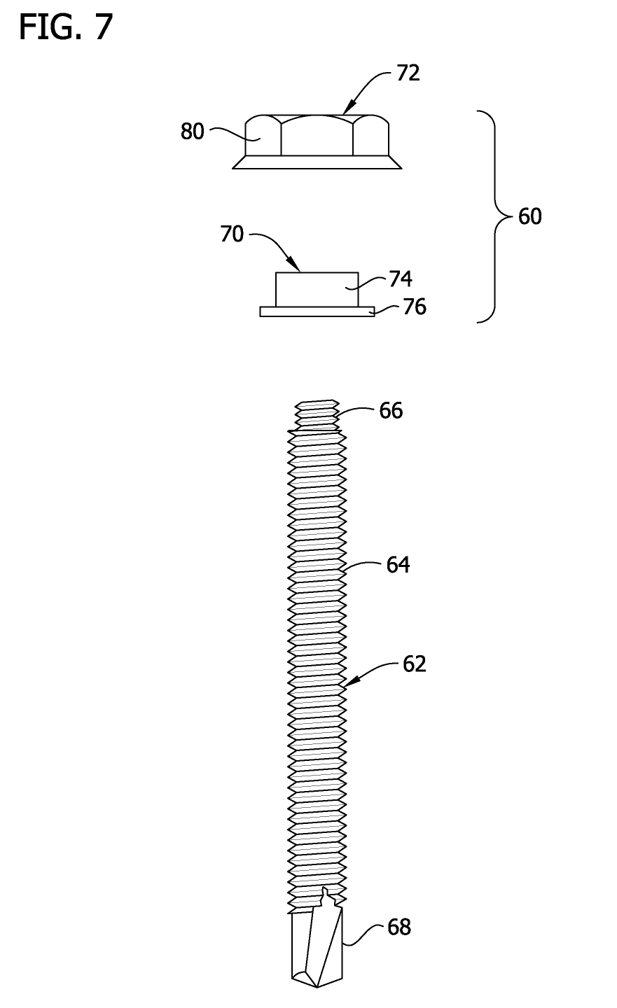

Referring to FIGS. 6 and 7, the fastener head 60 includes an internal portion 70 configured for connection to the attachment portion 66 of the fastener shaft 62 and an external portion 72 configured to provide a thermal break in the cavity. The internal portion 70 includes a nut 74 and a washer 76. The nut 74 and washer 76 are preferably made of metal, such as stainless steel or any other suitable metal, to provide a secure and strong attachment to the fastener shaft 62. The nut 74 and washer 76 can be integrally formed, or can be separate pieces. A threaded opening 78 extends through the washer 76 and partially through the nut 74. The threaded opening 78 is configured for engagement with the threaded attachment portion 66 on the fastener shaft 62.

The internal portion 70 is positioned within the external portion 72 to provide a thermal break. The external portion 72 comprises a casing 80 configured to receive the nut 74 and washer 76 of the internal portion 70. The casing 80 preferably defines a standard hex head and is formed from a thermally-isolating material. Although any suitable material could be used, the casing 80 is preferably constructed of a material which, in addition to having low thermal conductivity (such as the materials described above), also has sufficient hardness and resistance to abrasion to allow the casing to be engaged by a driving tool (not shown) and used to drive the fastener 48 into a stud or wall. The internal portion 70 can be attached to the casing 80 in any suitable manner, such as by snap fit. Alternatively, the casing 80 can be over molded on the internal portion 70. The casing 80 preferably fully encases the internal portion 70, including particularly the washer 76, such that no part of the internal portion is exposed when the fastener head 60 and fastener shaft 62 are connected, thereby preventing metal-to-metal contact at the juncture of the fastener head and the anchor 40 when the fastener 48 is in use. The casing 80 preferably has a thickness selected to provide a thermal break in the cavity. Although shown and described as a separate structure, preferably the casing 80 can be a thermal coating molded onto the internal portion 70. In one embodiment, the entire fastener 48 can be coated after the fastener head 60 is attached to the fastener shaft 62.

The casing 80 reduces the K-value of the underlying metal components which include, but are not limited to, mill galvanized, hot galvanized, and stainless steel. Such components have K-values that range from 16 to 116 W/(m·K). The casing 80 reduces the K-value of the fastener 48 to not exceed 1.0 W/(m·K). Desirably, the use of fasteners as described herein may be able to reduce the U-value of a wall between 5% and 80%. Tests have indicated an improvement of about 30%-40%. The casing 80 is fire resistant and gives off no toxic smoke in the event of a fire. Additionally, the casing 80 can provide corrosion protection which protects against deterioration of the anchoring system over time.

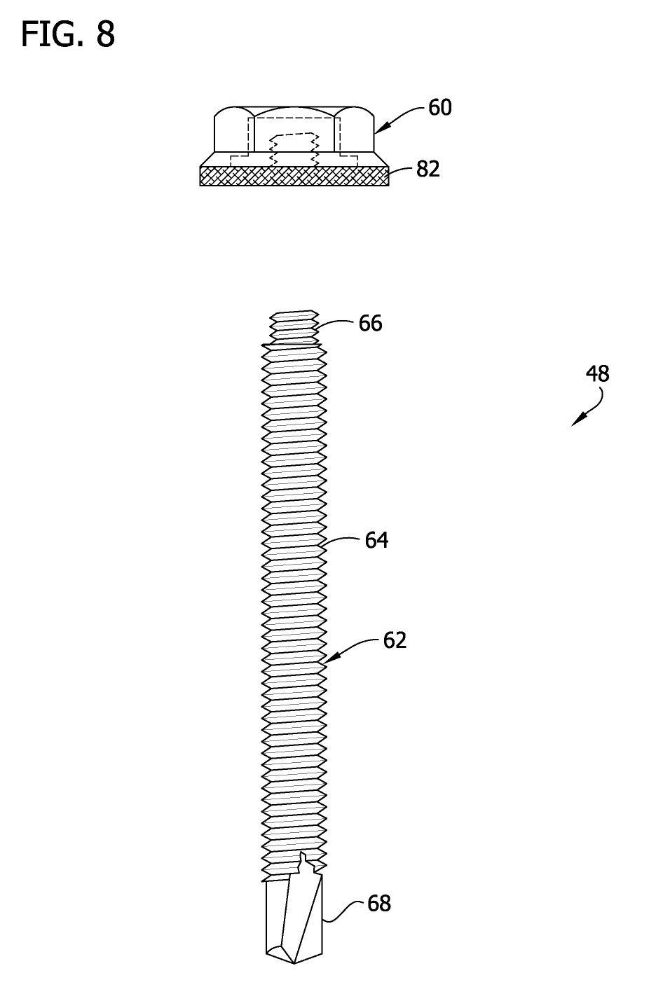

As seen in FIG. 8, the fastener 48 can optionally include an annular barrier piece 82 (e.g., a neoprene washer) adjacent a bottom surface of the fastener head 60. The an annular barrier piece 82 provides an additional thermal barrier between the anchor 40 and the fastener head 60, and also helps maintain insulation integrity by covering the entry opening of the fastener 48.

Although a folded wall anchor is illustrated in FIGS. 1 and 2, other surface mounted anchors can be attached with the thermally-isolating fasteners described herein, such the wall anchors as described in U.S. Pat. No. 6,941,717; U.S. Pat. No. 7,325,366; U.S. Pat. No. 7,587,874; U.S. Pat. No. 8,201,374, or any other surface mounted anchor. Additionally, the thermally-isolating fasteners can be used with different cavity wall structures, such as cavity walls having alternative inner wythe constructions (e.g., masonry backup, etc.).

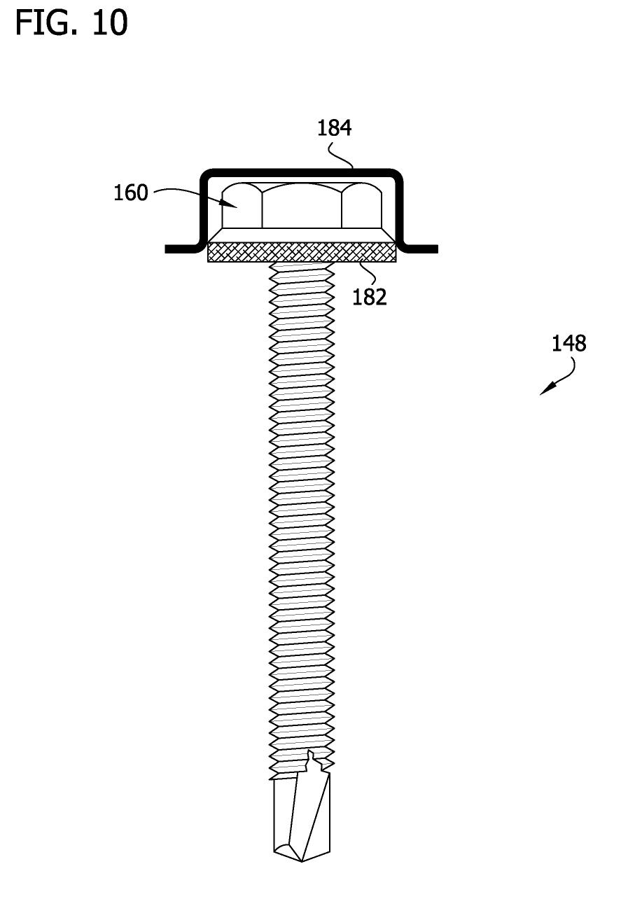

FIGS. 10-12 illustrate alternate embodiments of thermally-isolating fasteners for use with surface-mounted wall anchors. Corresponding reference numbers are used to refer to corresponding elements. Where elements are substantially similar to the embodiments described above, they will not be described in detail again below.

In the embodiment of FIG. 10, a separate thermal cap 184 can be attached to the fastener head 160. The thermal cap 184 can be made of a suitable low thermal conductivity material such as described elsewhere here. In this embodiment, the fastener 148 can be a standard self-drilling metal screw with integral fastener head, or can be a screw as described above with a selectively attachable fastener head and/or a plastic casing on the head. All or a portion of the fastener 148 can include a thermal coating as described above. Optionally, an annular barrier piece 182 (e.g., a neoprene washer) is positioned adjacent a bottom surface of the fastener head 160, as described above with reference to FIG. 8.

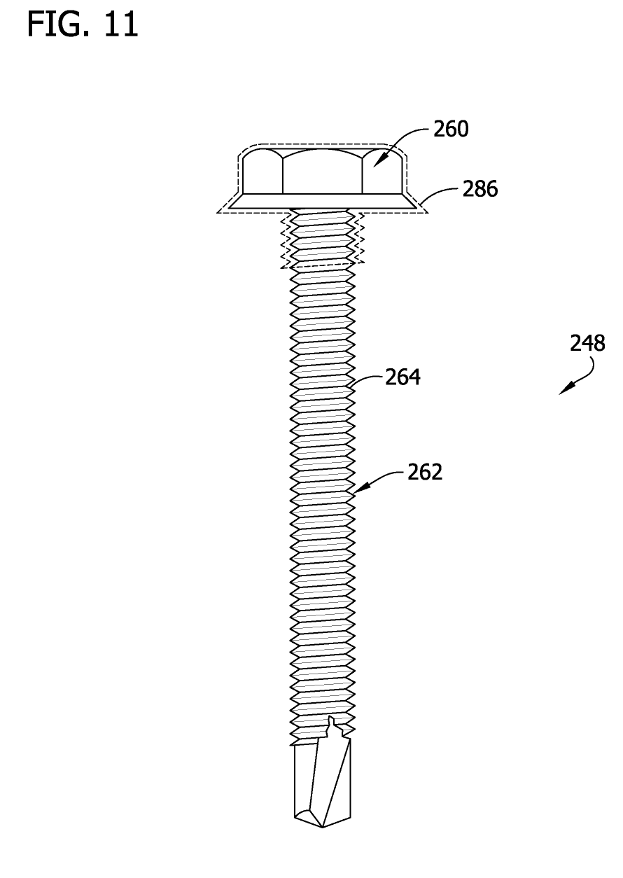

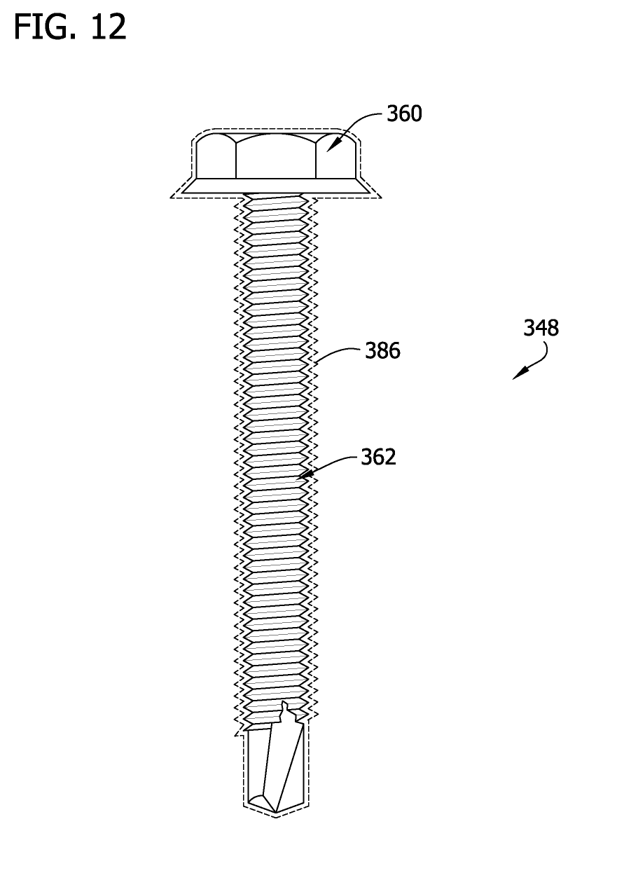

In the embodiment illustrated in FIG. 11, the fastener 248 includes a thermal coating 286 over the fastener head 260 and part (e.g., at least three threads) of the screw portion 264 of the fastener shaft 262, leaving the remainder of the fastener shaft without a thermal coating. In the embodiment of FIG. 12, the entire fastener 348, including the fastener head 360 and the fastener shaft 362, includes a thermal coating 386.

The fasteners as described above serve to thermally isolate the components of the anchoring system, thereby reducing the thermal transmission and conductivity values of the anchoring system as a whole. The fasteners provide an insulating effect and an in-cavity thermal break, severing the thermal pathways created from metal-to-metal contact of anchoring system components. Through the use of the thermally-isolating fastener, the underlying metal components obtain a lower thermal conductive value (K-value), thereby reducing the thermal transmission value (U-value) of the entire cavity wall structure. The present invention maintains the strength of the metal and further provides the benefits of a thermal break in the cavity.

Having described the invention in detail, it will be apparent that modifications and variations are possible without departing from the scope of the invention defined in the appended claims.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above products without departing from the scope of the invention, it is intended that all matter contained in the above description and shown in the accompanying drawings shall be interpreted as illustrative and not in a limiting sense.

1. A thermally-isolating fastener for use in a cavity wall to connect a wall anchor to an inner wythe, the fastener comprising:
a fastener shaft having a screw portion including a driven end and an attachment portion opposite the driven end; and
a fastener head selectively attachable to the attachment portion of the fastener shaft, the fastener head comprising an internal portion and an external portion encasing the internal portion and configured to provide a thermal break in the cavity wall when installed, wherein the external portion fully encases the internal portion such that no part of the internal portion is exposed when the fastener head is attached to the attachment portion of the fastener shaft.

2. The fastener of claim 1, wherein the external portion comprises a casing configured to receive the internal portion.

3. The fastener of claim 2, wherein the external portion comprises a first material and the internal portion comprises a second material different from the first material.

4. The fastener of claim 3, wherein the fastener shaft and the internal portion are made of thermally-conductive material and the external portion is made of thermally nonconductive material to provide a thermal break and reduce the thermal conductivity of the fastener shaft and the internal portion.

5. The fastener of claim 4, wherein the fastener shaft and the internal portion are steel.

6. The fastener of claim 5, wherein the external portion is thermoplastic.

7. The fastener of claim 6, wherein the fastener shaft includes a polymer coating.

8. The fastener of claim 7, further comprising a thermal coating disposed on the fastener shaft.

9. The fastener of claim 6, wherein the screw portion has a first diameter and the attachment portion comprises a threaded stud having a second diameter smaller than the first diameter.

10. The fastener of claim 7, wherein the internal portion comprises a washer and a nut positioned within the external portion, the washer and nut each having a threaded opening configured to receive the attachment portion of the fastener shaft.

11. The fastener of claim 8, further comprising a thermal barrier piece positioned at a juncture of the fastener shaft and the fastener head.

12. An anchoring system for use in a cavity wall having an inner wythe and an outer wythe spaced from the inner wythe and forming a cavity therebetween, the anchoring system comprising:
a wall anchor configured for attachment to the inner wythe, the wall anchor comprising a mounting surface configured for engagement with an exterior surface of the inner wythe and a receptor configured for engagement with a veneer tie, the wall anchor defining at least one mounting opening; and
at least one thermally-isolating fastener configured to extend through the at least one mounting opening to attach the wall anchor to the inner wythe, the at least one thermally-isolating fastener comprising:
a fastener shaft having a screw portion including a driven end and an attachment portion opposite the driven end; and
a fastener head selectively attachable to the attachment portion of the fastener shaft, the fastener head comprising an internal portion and an external portion encasing the internal portion and configured to provide a thermal break in the cavity wall when installed, wherein the external portion fully encases the internal portion such that no part of the internal portion is exposed when the fastener head is attached to the attachment portion of the fastener shaft.

13. The anchoring system of claim 12, wherein the external portion comprises a casing configured to receive the internal portion.

14. The anchoring system of claim 13, wherein the external portion comprises a first material and the internal portion comprises a second material different from the first material.

15. The anchoring system of claim 14, wherein the fastener shaft and the internal portion are made of thermally-conductive material and the external portion is made of nonconductive material to provide a thermal break and reduce the thermal conductivity of the fastener shaft and the internal portion.

16. The anchoring system of claim 15, wherein the fastener shaft and the internal portion are steel and the external portion is thermoplastic.

17. The anchoring system of claim 16, further comprising a thermal coating disposed on the fastener shaft.

18. The anchoring system of claim 15, wherein the screw portion has a first diameter and the attachment portion comprises a threaded stud having a second diameter smaller than the first diameter.

19. The anchoring system of claim 18, wherein the internal portion comprises a washer and a nut positioned within the external portion, the washer and nut each having a threaded opening configured to receive the attachment portion of the fastener shaft.

20. The anchoring system of claim 19, further comprising a thermal barrier piece positioned at a juncture of the fastener shaft and the fastener head.
